(19) United States
(12) Patent Application Publication
(10) Pub. No.: US 2026/0164262 A1
(43) Pub. Date: Jun. 11, 2026

(54) APPARATUSES AND METHODS FOR FACILITATING ENHANCEMENTS IN A CONFIGURATION SUPPORTING A COMMUNICATION SERVICE BASED ON USAGE AND PERFORMANCE DATA

(71) Applicants: AT&T Intellectual Property I, L.P., Atlanta, GA (US); AT&T Mobility II LLC, Atlanta, GA (US)

(72) Inventors: Stephen Thomas Hardin, Suwanee, GA (US); Yupeng Jia, South Pasadena, CA (US); Anthony Dalby, Carrollton, TX (US); James H. Pratt, Round Rock, TX (US)

(73) Assignees: AT&T Intellectual Property I, L.P., Atlanta, GA (US); AT&T Mobility II LLC, Atlanta, GA (US)

(21) Appl. No.: 18/976,581

(22) Filed: Dec. 11, 2024

(51) Int. Cl. H04W 24/02; H04W 72/543

(52) U.S. Cl. CPC H04W 24/02; H04W 72/543

(57) ABSTRACT

Aspects of the subject disclosure may include, for example obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. Other embodiments are disclosed.

### FIELD OF THE DISCLOSURE

The subject disclosure relates to apparatuses and methods for facilitating enhancements in a configuration supporting a communication service based on usage and performance data.

### BACKGROUND

Vast communication networks and systems, and various communication devices, are used to provision communication services. A wireless communication device is an example of a client device/user equipment that enables a user to access communication services, while still allowing the user an opportunity to move or change locations. Conventionally, a client device connects to network/system resources to facilitate access to communication services. In some instances, such as due to mobility, it may be the case that the client device is unable to remain connected to the network/system resources, which can lead to a need to facilitate a handover to other network/system resources to maintain continuity of service, or can lead to a(n abrupt) termination of the service if such other network/system resources are unable or unavailable to facilitate the service. Thus, conventionally, aspects of provisioning communication services tend to be reactive in nature and fail to account for various circumstances and conditions that impact quality of service and quality of experience.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for selecting (e.g., optimizing) a configuration for accessing a wireless communication service based on usage data/information and performance data/information. Other embodiments are described in the subject disclosure.

One or more aspects of the subject disclosure include, in whole or in part, obtaining first data defining a wireless usage zone associated with at least one client device; obtaining second data defining at least one communication service that is likely to be requested in conjunction with the wireless usage zone; obtaining third data defining a performance of a communication network or system for supporting the at least one communication service; determining, based on an analysis of the first data, the second data, and the third data, that a quality of the at least one communication service is likely to fail satisfying a threshold; and identifying, based on the determining, at least one action for enhancing the quality of the at least one communication service.

One or more aspects of the subject disclosure include, in whole or in part, identifying, using machine learning, artificial intelligence, or a combination thereof, a first application that is likely to be executed by a first user equipment of a first user for obtaining access to a first communication service, resulting in a first identification; determining, based on the first identification, a first quality of service that is likely to be obtained in respect of a provisioning of the first communication service via a first resource of a network operator, resulting in a first determination; determining, based on the first determination, that the first quality of service exceeds a threshold, resulting in a second determination; and allocating, based on the second determination, the first resource to facilitate the first communication service.

One or more aspects of the subject disclosure include, in whole or in part, identifying, by a processing system including a processor, a usage zone in respect of a user of a communication device in terms of a range of geographical locations and a range of times; identifying, by the processing system, a wireless communication service that is likely to be requested by the user via the communication device within the usage zone; identifying, by the processing system, resources that are available to support the wireless communication service within the usage zone; and generating, by the processing system, an indication of an expected performance of the wireless communication service as supported by the resources.

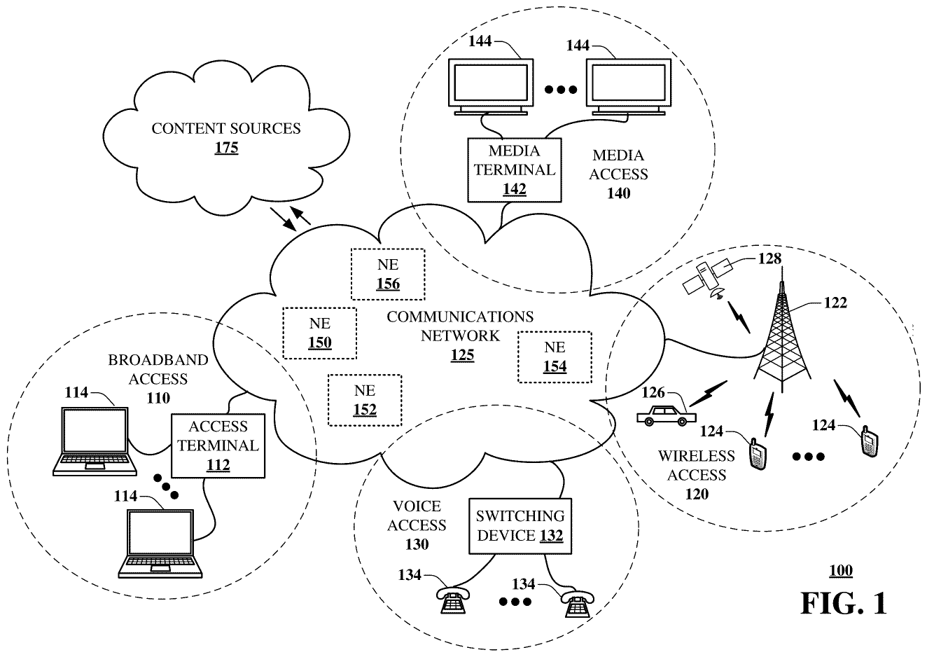

Referring now to FIG. 1, a block diagram is shown illustrating an example, non-limiting embodiment of a system 100 in accordance with various aspects described herein. For example, the system 100 can facilitate, in whole or in part, obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. The system 100 can facilitate, in whole or in part, identifying, using machine learning, artificial intelligence, or a combination thereof, a first application that is likely to be executed by a first user equipment of a first user for obtaining access to a first communication service, resulting in a first identification, determining, based on the first identification, a first quality of service that is likely to be obtained in respect of a provisioning of the first communication service via a first resource of a network operator, resulting in a first determination, determining, based on the first determination, that the first quality of service exceeds a threshold, resulting in a second determination, and allocating, based on the second determination, the first resource to facilitate the first communication service. The system 100 can facilitate, in whole or in part, identifying, by a processing system including a processor, a usage zone in respect of a user of a communication device in terms of a range of geographical locations and a range of times, identifying, by the processing system, a wireless communication service that is likely to be requested by the user via the communication device within the usage zone, identifying, by the processing system, resources that are available to support the wireless communication service within the usage zone, and generating, by the processing system, an indication of an expected performance of the wireless communication service as supported by the resources.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122 (and/or via satellite 128), voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may be utilized to enhance quality of service (QoS) or quality of experience (QoE) in relation to a provisioning of one or more communication services. A prediction may be generated regarding a user's likely location(s) at points in the future, along with a prediction about the types of communication services or applications that the user is likely to need or utilize while at those locations. Further, a prediction may be made/generated regarding the time or duration that the user is likely to utilize the communication services or applications. In this respect, a profile for the user may be generated regarding the user's likely behaviors as it relates to access/utilization of communication services/applications. Furthermore, profiles may be established and maintained regarding network/system performance and device performance. Taken individually or in the aggregate, the various pieces/items of data and information may be analyzed (potentially by way of a use of one or more models, algorithms, technologies, etc.) to facilitate a prediction or determination of expected network/system performance on a user specific basis (or, analogously, on a device specific basis). Based on the prediction/determination, candidates may be identified for facilitating a given communication service or application, where the candidates may include or pertain to a type (e.g., make and model) of device to use, a version of an application to execute/run, a communication network/system resource to utilize, etc.

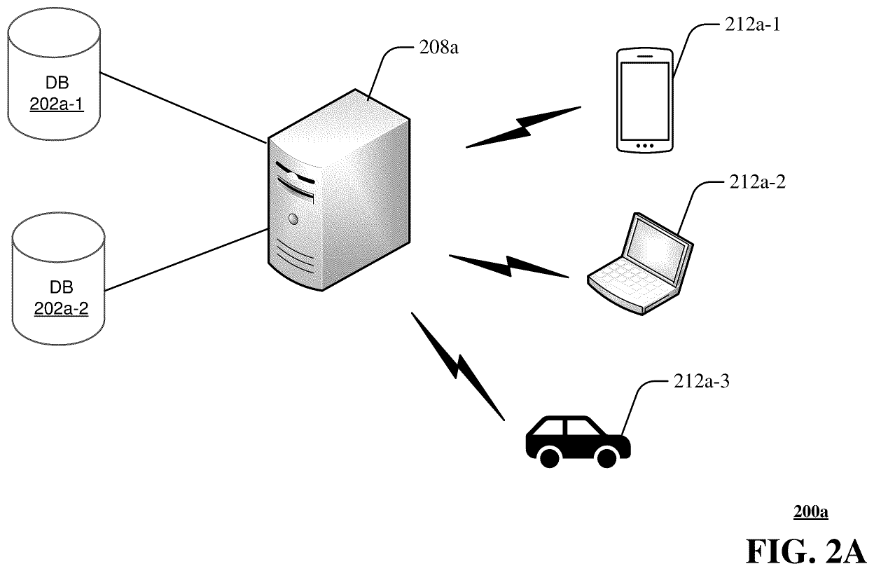

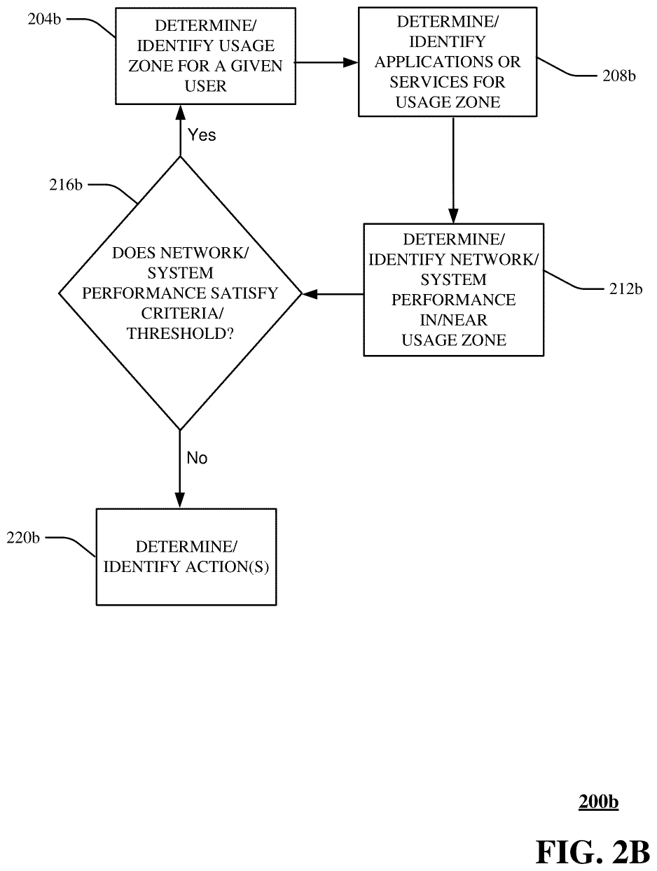

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system 200a may include one or more devices or entities, such as for example a first database (DB) 202a-1, a second DB 202a-2, a network/system node 208a (e.g., a server), and one or more client devices/user equipment (UEs), such as a first client device 212a-1, a second client device 212a-2, and a third client device 212a-3. In some embodiments, the first DB 202a-1 and the second DB 202a-2 may be included/incorporated within a common housing or casing (which is to say that the DBs 202a-1 and 202a-2 may be combined/consolidated without incurring any loss in the accuracy of this description). In some embodiments, the node 208a may be included at or near an edge of a network/system associated with the system 200a, which may be useful in facilitating low-latency communications/signaling between the node 208a and client devices (e.g., the client devices 212a-1, 212a-2, and 212a-3). In some embodiments, the node 208a may be included as part of a cloud computing platform/topology, as part of a back-end server system/farm, etc. The client devices 212a-1, 212a-2, and 212a-3 may include any type or kind (e.g., make and model) of device. For example, in an illustrative embodiment the first client device 212a-1 may include a smartphone, the second client device 212a-2 may include a laptop, and the third client device 212a-3 may include (or may be incorporated as part of) a connected vehicle. The use/representation of three client devices in FIG. 2A is illustrative, which is to say that more or fewer than three client devices may be included in a given embodiment.

In operation, and as described in further detail below, the first DB 202a-1 may be used to store information/data pertaining to users, potentially as part of one or more profiles (e.g., each user may have a specific/dedicated profile). The second DB 202a-2 may be used to store data/information pertaining to network/system performance.

Regarding the user information/data of the first DB 202a-1, the data/information may be at least partially sourced from an application (which may, illustratively, be referred to herein as a wireless performance app) executing on a client device of an associated user. The user data/information may include: an identification of a location of the client device, a timestamp associated with the location, applications or services (e.g., communication services) that are executed/utilized while at the location, other users or devices (e.g., “contacts”) that the user/client device is in communication with while at the location (potentially inclusive of the form of the communication that is used (e.g., voice, text, email, videoconferencing, etc.)), etc.

Over a period of time, the information/data for the user or client device may be collected and combined with mapping location information, which in turn may establish a record of the user's locations in conjunction with a utilization of the client device. The relative amounts of time during which the user is present in/at certain locations or areas may be represented in one or more forms, such as a heat map with a longer duration of presence being signified or distinguished from a shorter duration or presence (such as by way of color coding, for example). In some embodiments, the heat map may be included/incorporated as part of a graphic or visual presentation. In this manner, it may be easily perceived as to which areas or locations are typically important for the user to have a high-quality performance/experience versus other areas or locations that the user is rarely, if ever, present.

In some embodiments, a collection or aggregation of information/data for a user (in terms of, e.g., user location and network/system usage by way of communication services or applications) may be utilized to define a set of usage zones for the user. Each zone of the set of usage zones may have a number of characteristics associated with it that describe the user's typical usage of services while in that zone. For example, the characteristics may include an identification of: presence (e.g., how often or how long the user is there), whether the user is active (e.g., actively initiating transfers or conveyances of data) or passive (e.g., is merely waiting to receive data), whether the user is indoors or outdoors (e.g., is/are the location(s) inside or outside of a building, aboveground or underground, etc.), whether the application(s) or service(s) that are used require high bandwidth (e.g., bandwidth in an amount greater than a threshold) or low latency (e.g., latency in an amount less than a threshold), trends in terms of location (e.g., an indication of whether the user has visited the location or area recently; an indication of whether the user visits to the location or area are becoming more frequent or less frequent over time), etc.

The information/data for the user (as may be stored in, e.g., the first DB 202a-1) may be analyzed (by the node 208a or another node) to generate a prediction regarding the user's likely behaviors over time, as those behaviors relate to a use/consumption of communication services (or, analogously, applications). For example, it may be the case that, based on an analysis of the information/data, it can be inferred that the user recently started taking a liking to visiting parks during the month of June. Based on this insight, a prediction may be generated that the user is likely to visit another park while on vacation next month in July (where an indication of the vacation may be present on an electronic calendar associated with the user). This prediction may be used to guide determinations/identifications of network/system resources to be used or allocated in July, recommendations or suggestions for client devices to be used by the user in July, etc. Information or data regarding a given user, including any predictions of the user's future behaviors or actions, may be stored as part of the first DB 202a-1.

The wireless performance app (or another application or app) may contribute/provide information/data to the node 208a (or another node) for storage in the second DB 202a-2 describing wireless performance characteristics for the associated client device. For example, the characteristics may include an identification of a configuration of the client device (e.g., make and model identifiers, application or operating system version identifiers, etc.), bandwidth data, signal strength data, latency data, frequency band data, antenna data, etc., for connections over a period of time, potentially in conjunction with location and timestamp identifiers. These wireless performance characteristics may be collected by the wireless performance app as part of a background task, which is to say that the associated client device might not present (indicators of the) characteristics to a user. It is noted that this process of collecting information/data describing wireless performance characteristics may occur for multiple devices (e.g., multiple client devices), where such devices may be associated with one or more users. In this respect, a rich/voluminous knowledgebase of performance may be generated or established.

The wireless performance characteristics may be analyzed by, e.g., the node 208a (or another node) to define geographical regions or zones that reflect similar levels of wireless performance (e.g., levels of wireless performance that are within a threshold of one another or within a range of values). It is noted that the regions/zones of wireless performance might not be static in nature, but may be dynamic in nature. For example, the regions/zones of wireless performance may be updated or modified as additional information/data is obtained/acquired. Thus, a first location included in a first zone at a first point in time might not be included as part of the first zone at another point in time. Similarly, a second location that is not included in the first zone at the first point in time may be included as part of the first zone at the second point in time (or another point in time).

The wireless performance regions/zones may be examined to determine/identify those areas or locations that provide good wireless performance (as potentially expressed relative to one or more thresholds)—e.g., good coverage and bandwidth, or analogously those areas or locations that suffer from poor coverage or bandwidth. It is noted that various parameters/factors may influence the wireless performance that is obtained/realized, such as for example geographic or created landscapes (e.g., mountains or urban canyons), network/system infrastructure (e.g., tower or base station) placements, etc. The definition of the wireless performance regions/zones may be stored as part of the second DB 202a-2.

The user usage data (as represented in the first DB 202a-1, and as potentially expressed in terms of access to, or usage of, communication services or applications, on an actual or predicted basis) and the network/system performance data (as represented in the second DB 202a-2, and as potentially expressed in terms of actual or predicted wireless performance) may be analyzed by, e.g., the node 208a (or another node) to assess or predict a given user's (or, analogously, a given wireless device's) expected/anticipated wireless performance experience. The analysis may be performed periodically, on-demand, in response to a user-generated input, in response to changes in circumstances or conditions, etc. The analysis may be aided by, or may be based on a use of, one or more models, algorithms, technologies (e.g., artificial intelligence, machine learning, etc.), or the like. The expected/anticipated wireless performance experience may pertain to a user's current wireless device, or a recommended/suggested different device (e.g., a device that the user may be given an option to upgrade to, potentially in conjunction with a service/subscription agreement or contract). In some embodiments, the user (potentially by way of an associated client device or application—e.g., the wireless performance app) may be presented with one or more indicators of how much better the performance may be if the user opts to utilize the different device (relative to the current wireless device), which may serve to entice the user to use the different device, purchase the different device, etc.

It is noted that the analysis described above in terms of facilitating a determination of a device to use (e.g., a current wireless device versus an upgraded wireless device) may similarly be applied in respect of a communication network to use. For example, a current, first communication network may provide a first level of performance, whereas a second communication network may provide a second level of performance that is different from (e.g., better than) the first level of performance. In some embodiments, the user (potentially by way of an associated client device or application—e.g., the wireless performance app) may be presented with one or more indicators of how much better the performance may be if the user opts to utilize the second communication network (relative to the first communication network), which may serve to entice the user to use the second communication network, become a subscriber of an operator of the second communication network, etc.

It is noted that there may not be an exact overlap between user usage data and network/system (wireless) performance data (in terms of location, time, etc.). To demonstrate, if in a given embodiment a particular/identified user's usage data is associated with an office where the user works, it may be the case that the network/system performance data varies greatly throughout the office. For example, the network/system performance data may indicate that performance is greater/better in a conference room of the office relative to a cafeteria or lunchroom of the office. Aspects of this disclosure may account for these differences by, e.g., generating an average of the expected performance based on where the user is anticipated being located within the office on a given day, recommending to the user to use a particular device or a particular network (e.g., Wi-Fi network or cellular network) when executing a particular application or utilizing a particular communication service, or when present in one room of the office (e.g., the conference room) versus another room of the office (e.g., the cafeteria), etc.

In some embodiments, a user may have an ability to prompt or advise the wireless performance app that the user intends to visit a location that is not part of the user's usage data. For example, the user may provide a set of geographic coordinates in relation to a mapping application (or the like) to specify where the user is intending to go. In some embodiments, the user may supply the information via a user interface, which may include a graphical user interface (GUI), a (soft) keyboard, a speech-to-text interface, or the like. The wireless performance app may provide the user with indications of the expected performance at or near (e.g., within a threshold distance of) the location corresponding to the specified set of geographic coordinates, where the expected performance may be determined by, e.g., the node 208a.

As the foregoing description and examples demonstrate, practical applications of this disclosure may be utilized to drive decision-making processes or logic in relation to provisioning communication services and applications. Aspects of this disclosure are based on a recognition that there are a multitude of factors or parameters that influence quality of service (QoS) or quality of experience (QoE) in relation to communication services, where such factors or parameters may include, but are not limited to, user mobility, user demand, noise, interference, environmental conditions, obstacles or obstructions, availability or capacity of resources, client device capabilities, etc. Aspects of this disclosure may be used to enhance user or client device QoS or QoE, while at the same time providing an ability to enhance efficiencies for a network/system operator or service provider (e.g., by making efficient use of scarce communication resources, such as spectrum, frequencies/frequency bands, or bandwidth). In some embodiments, tradeoffs may be made between QoS or QoE on the one hand, and efficiencies on the other hand. For example, it may be the case that in a particular embodiment or instance that a first user or first device should be allocated to a first resource (that is suboptimal relative to a second resource in terms of performance) to enable a second user or second device to gain access to a communication service or application.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 204b, a usage zone for a given user or device (or, analogously, a set of users or devices) may be determined or identified. The usage zone may correspond to a geographical location or region (as potentially defined by a set of coordinates - e.g., latitude, longitude, and altitude, or a range of geographical coordinates such as between a first latitude, a first longitude, and a first altitude and a second latitude, a second longitude, and a second altitude) at a given time (e.g., at 7 AM) or range of times (e.g., between 8 AM and 11 AM). The determination/identification of the usage zone as part of block 204b may be based on a user-generated input, such as user uttered speech—e.g., “I am going to be in the office on Monday morning”. The determination/identification of the usage zone as part of block 204b may be inferred, potentially based on historical patterns of behavior—e.g., the user frequently traveling to the office on Monday morning.

In block 208b, one or more applications or services (e.g., communication services) that may be requested may be determined/identified. For example, if the user has on entry on her electronic calendar indicating participation in a meeting scheduled for Monday at 10 AM, it may be assumed that the user may request access to voice communication services or videoconferencing services (or associated applications).

In block 212b, a performance of the network/system in respect of the usage zone (of block 204b) may be determined/identified. For example, the determination/identification of block 212b may be facilitated based on an analysis of data/information of past network/system performance in the usage zone, indicators of demand (actual or predicted) for communication resources in the usage zone, etc.

In block 216b, an analysis may be undertaken in respect of the data/information pertaining to the usage zone (of block 204b) relative to the applications or services that are likely to be needed or requested (as determined/identified in block 208b) in respect of the likely network/system performance in/near the usage zone (as determined/identified in block 212b). The analysis of block 216b may yield an indication of whether the performance satisfies criteria or metrics, where such criteria or metrics may be indicative of expected or anticipated qualities of service or qualities of experience. Assuming that the performance is sufficient (e.g., exceeds one or more thresholds), flow may proceed from block 216b to block 204b, to continue monitoring/defining the usage zone as time progresses. Conversely, if the performance is insufficient (e.g., is less than one or more thresholds), flow may proceed from block 216b to block 220b.

In block 220b, one or more actions may be determined or identified for remedying the expected/anticipated shortfall in performance. For example, and without limitation, as part of block 220b a user may be advised to: (1) purchase or utilize a different device (e.g., a different client device), (2) utilize a given network (e.g., change from using a first network or first radio access technology [RAT] to using a second network or second RAT), (3) modify an application that is used (e.g., upgrade a version of an application from a first version to a second version), (4) relocate to a different location (e.g., move from a first location to a second location), (5) modify a time for accessing a communication service or application (e.g., rescheduling the meeting from 10 AM to 11 AM). In some embodiments, the actions may be partially or fully automated by a device on behalf of the user, thereby alleviating the user of the need to specifically accept or take the actions. For example, and in respect of (2) above, a communication session may be handed over from the first RAT to the second RAT, potentially unbeknownst to the user.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of this disclosure may facilitate an artificial intelligence (AI) and/or machine learning (ML) based approach towards configuring wireless access as part of provisioning communication services. A customized or tailored approach may be utilized, whereby user usage data (indicative of user actions, behaviors, patterns, and the like) may be analyzed/assessed relative to indicators of network/system performance, to select (values for) parameters to facilitate a communication service for a given user or device (or a given set of users or devices). A given user or given device may benefit from performance indicators reported by other users or devices, such as for example in relation to a selection or purchase of the given device by the given user. Furthermore, configurations of devices, applications, and/or network/system resources may be based on historical data/information and/or current data/information, which may lead to more accurate/precise resource allocations/assignments.

In brief, and as demonstrated herein, the various aspects of this disclosure may be utilized as part of various practical applications representative of substantial improvements to technology. As such, the various aspects of this disclosure are not directed to abstract ideas. As one of skill in the art will appreciate, the various aspects of this disclosure are directed to, and encompass, significantly more than any abstract idea standing alone. Indeed, the various aspects of this disclosure facilitate a generation of transformative, useful, concrete, and tangible results. Further, the various aspects of this disclosure may leverage technologies (e.g., artificial intelligence, machine learning) in relation to particular machines or apparatuses to facilitate enhanced knowledge that might otherwise be lacking. Stated differently, users, network/system operators, or service providers might not even be aware of the circumstances or conditions influencing/impacting quality of service or quality of experience, such that quality of service or quality of experience may suffer in the absence of a use of such machines or apparatuses that are able to discern/account for such circumstances and conditions.

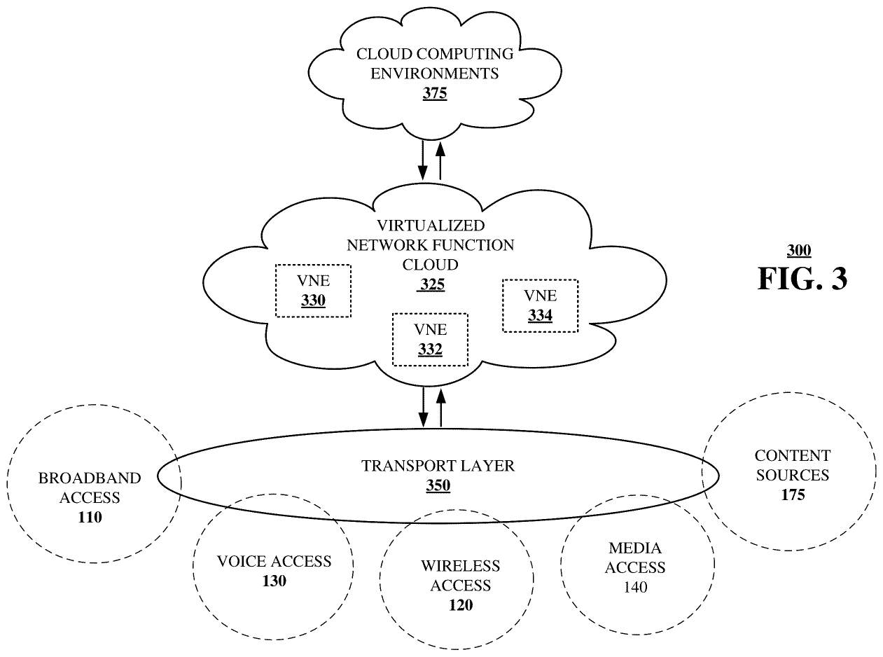

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, the virtualized communication network 300 can facilitate, in whole or in part, obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. The virtualized communication network 300 can facilitate, in whole or in part, identifying, using machine learning, artificial intelligence, or a combination thereof, a first application that is likely to be executed by a first user equipment of a first user for obtaining access to a first communication service, resulting in a first identification, determining, based on the first identification, a first quality of service that is likely to be obtained in respect of a provisioning of the first communication service via a first resource of a network operator, resulting in a first determination, determining, based on the first determination, that the first quality of service exceeds a threshold, resulting in a second determination, and allocating, based on the second determination, the first resource to facilitate the first communication service. The virtualized communication network 300 can facilitate, in whole or in part, identifying, by a processing system including a processor, a usage zone in respect of a user of a communication device in terms of a range of geographical locations and a range of times, identifying, by the processing system, a wireless communication service that is likely to be requested by the user via the communication device within the usage zone, identifying, by the processing system, resources that are available to support the wireless communication service within the usage zone, and generating, by the processing system, an indication of an expected performance of the wireless communication service as supported by the resources.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

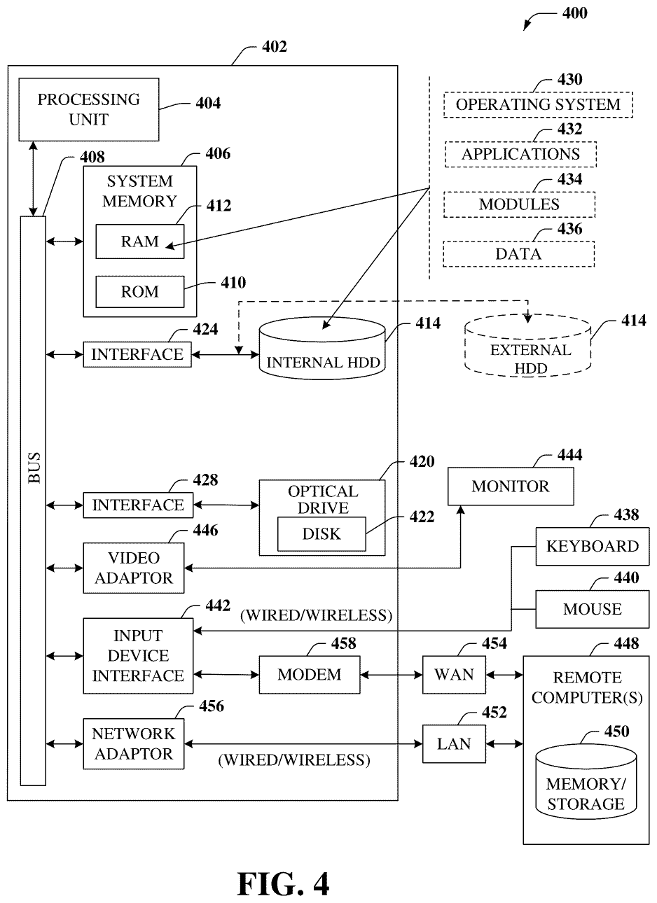

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. The computing environment 400 can facilitate, in whole or in part, identifying, using machine learning, artificial intelligence, or a combination thereof, a first application that is likely to be executed by a first user equipment of a first user for obtaining access to a first communication service, resulting in a first identification, determining, based on the first identification, a first quality of service that is likely to be obtained in respect of a provisioning of the first communication service via a first resource of a network operator, resulting in a first determination, determining, based on the first determination, that the first quality of service exceeds a threshold, resulting in a second determination, and allocating, based on the second determination, the first resource to facilitate the first communication service. The computing environment 400 can facilitate, in whole or in part, identifying, by a processing system including a processor, a usage zone in respect of a user of a communication device in terms of a range of geographical locations and a range of times, identifying, by the processing system, a wireless communication service that is likely to be requested by the user via the communication device within the usage zone, identifying, by the processing system, resources that are available to support the wireless communication service within the usage zone, and generating, by the processing system, an indication of an expected performance of the wireless communication service as supported by the resources.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high-capacity optical media such as the DVD). The HDD 414 and optical disk drive 420 can be connected to the system bus 408 by a hard disk drive interface 424, and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

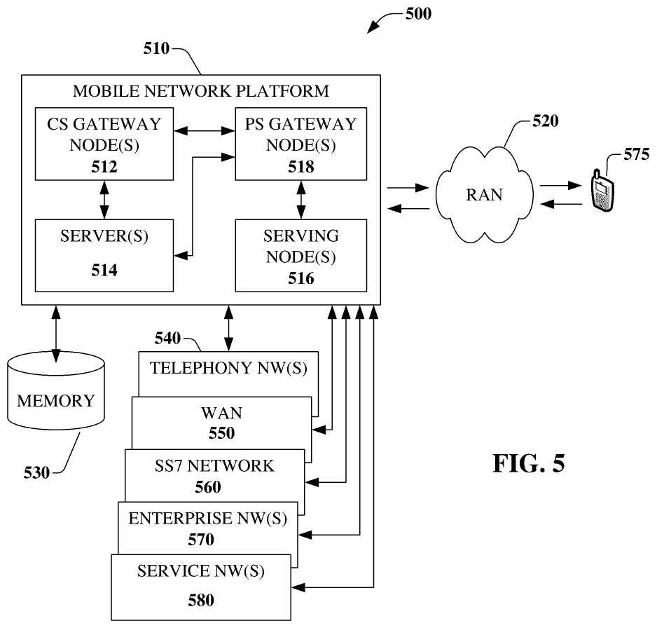

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. The platform 510 can facilitate, in whole or in part, identifying, using machine learning, artificial intelligence, or a combination thereof, a first application that is likely to be executed by a first user equipment of a first user for obtaining access to a first communication service, resulting in a first identification, determining, based on the first identification, a first quality of service that is likely to be obtained in respect of a provisioning of the first communication service via a first resource of a network operator, resulting in a first determination, determining, based on the first determination, that the first quality of service exceeds a threshold, resulting in a second determination, and allocating, based on the second determination, the first resource to facilitate the first communication service. The platform 510 can facilitate, in whole or in part, identifying, by a processing system including a processor, a usage zone in respect of a user of a communication device in terms of a range of geographical locations and a range of times, identifying, by the processing system, a wireless communication service that is likely to be requested by the user via the communication device within the usage zone, identifying, by the processing system, resources that are available to support the wireless communication service within the usage zone, and generating, by the processing system, an indication of an expected performance of the wireless communication service as supported by the resources.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

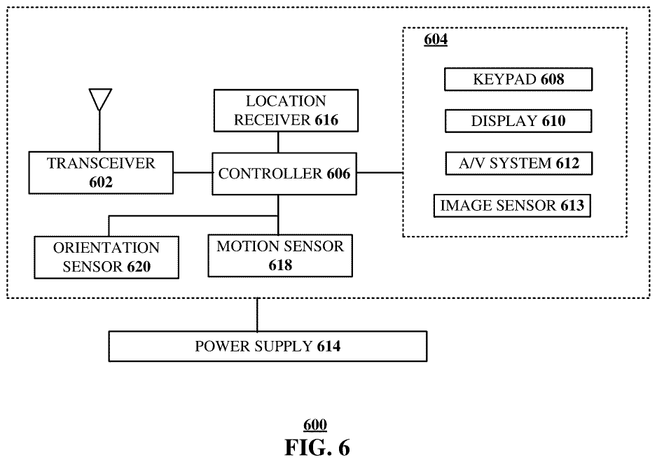

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining first data defining a wireless usage zone associated with at least one client device, obtaining second data defining at least one communication service that is likely to be requested in conjunction with the wireless usage zone, obtaining third data defining a performance of a communication network or system for supporting the at least one communication service, determining, based on an analysis of the first data, the second data, and the third data, that a quality of the at least one communication service is likely to fail satisfying a threshold, and identifying, based on the determining, at least one action for enhancing the quality of the at least one communication service. The computing device 600 can facilitate, in whole or in part, identifying, using machine learning, artificial intelligence, or a combination thereof, a first application that is likely to be executed by a first user equipment of a first user for obtaining access to a first communication service, resulting in a first identification, determining, based on the first identification, a first quality of service that is likely to be obtained in respect of a provisioning of the first communication service via a first resource of a network operator, resulting in a first determination, determining, based on the first determination, that the first quality of service exceeds a threshold, resulting in a second determination, and allocating, based on the second determination, the first resource to facilitate the first communication service. The computing device 600 can facilitate, in whole or in part, identifying, by a processing system including a processor, a usage zone in respect of a user of a communication device in terms of a range of geographical locations and a range of times, identifying, by the processing system, a wireless communication service that is likely to be requested by the user via the communication device within the usage zone, identifying, by the processing system, resources that are available to support the wireless communication service within the usage zone, and generating, by the processing system, an indication of an expected performance of the wireless communication service as supported by the resources.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first data defining a wireless usage zone associated with at least one client device;
obtaining second data defining at least one communication service that is likely to be requested in conjunction with the wireless usage zone;
obtaining third data defining a performance of a communication network or system for supporting the at least one communication service;
determining, based on an analysis of the first data, the second data, and the third data, that a quality of the at least one communication service is likely to fail satisfying a threshold; and
identifying, based on the determining, at least one action for enhancing the quality of the at least one communication service.

2. The device of claim 1, wherein the first data defines the wireless usage zone in terms of a range of geographical locations.

3. The device of claim 1, wherein the first data defines the wireless usage zone in terms of a range of times.

4. The device of claim 1, wherein the second data indicates that the at least one communication service is likely to be requested by the at least one client device.

5. The device of claim 1, wherein the second data indicates that the at least one communication service is likely to be requested by a second client device that is different from the at least one client device.

6. The device of claim 1, wherein the second data indicates that the at least one communication service is likely to be requested with a probability that is greater than a second threshold.

7. The device of claim 1, wherein the at least one client device comprises a plurality of client devices.

8. The device of claim 1, wherein the at least one communication service comprises a plurality of communication services.

9. The device of claim 1, wherein the at least one action comprises utilizing a second client device for obtaining access to the at least one communication service.

10. The device of claim 1, wherein the at least one action comprises utilizing a second communication network or system for supporting the at least one communication service.

11. The device of claim 1, wherein the at least one action comprises modifying a version of an application from a first version to a second version for supporting the at least one communication service.

12. The device of claim 1, wherein the at least one action comprises relocating from a first location to a second location.

13. The device of claim 1, wherein the at least one action comprises modifying a time for accessing the at least one communication service from a first time to a second time.

14. The device of claim 1, wherein the obtaining of the first data is based on obtaining a user-generated input.

15. The device of claim 1, wherein the obtaining of the first data is based on an analysis of historical data pertaining to: patterns of movement of a user of the at least one client device, communication services accessed by the user, and other users that the user has been in contact with.

16. A non-transitory machine-readable medium, comprising executable instructions that, when executed by a processing system including a processor, facilitate performance of operations, the operations comprising:
identifying, using machine learning, artificial intelligence, or a combination thereof, a first application that is likely to be executed by a first user equipment of a first user for obtaining access to a first communication service, resulting in a first identification;
determining, based on the first identification, a first quality of service that is likely to be obtained in respect of a provisioning of the first communication service via a first resource of a network operator, resulting in a first determination;
determining, based on the first determination, that the first quality of service exceeds a threshold, resulting in a second determination; and
allocating, based on the second determination, the first resource to facilitate the first communication service.

17. The non-transitory machine-readable medium of claim 16, wherein the operations further comprise:
identifying, using machine learning, artificial intelligence, or the combination thereof, a second application that is likely to be executed by a second user equipment of a second user for obtaining access to a second communication service, resulting in a second identification;
determining, based on the second identification, a second quality of service that is likely to be obtained in respect of a provisioning of the second communication service via a second resource of the network operator, resulting in a third determination;
determining, based on the third determination, that the second quality of service fails to satisfy the threshold, resulting in a fourth determination; and
allocating, based on the fourth determination, a third resource of the network operator to facilitate the second communication service.

18. The non-transitory machine-readable medium of claim 17, wherein the second resource includes a first frequency band and the third resource includes a second frequency band.

19. A method, comprising:
identifying, by a processing system including a processor, a usage zone in respect of a user of a communication device in terms of a range of geographical locations and a range of times;
identifying, by the processing system, a wireless communication service that is likely to be requested by the user via the communication device within the usage zone;
identifying, by the processing system, resources that are available to support the wireless communication service within the usage zone; and
generating, by the processing system, an indication of an expected performance of the wireless communication service as supported by the resources.

20. The method of claim 19, further comprising:
providing, by the processing system, the indication to the communication device such that the communication device presents the indication to the user.
